(19) United States
(12) Patent Application Publication
(10) Pub. No.: US 2022/0111441 A1
(43) Pub. Date: Apr. 14, 2022

(54) METHOD OF ADDITIVE MANUFACTURING WITH SEPARATION VIA A FRANGIBLE ZONE

(71) Applicants: SAFRAN, Paris (FR); SAFRAN AIRCRAFT ENGINES, Paris (FR)

(72) Inventors: Sébastien Yohann POUZET, Mosssy-Cramayel (FR); Guillaume Valentin Gianmondo MARION, Mosssy-Cramayel (FR)

(73) Assignees: SAFRAN, Paris (FR); SAFRAN AIRCRAFT ENGINES, Paris (FR)

(21) Appl. No.: 17/425,968

(22) PCT Filed: Feb. 7, 2020
(86) PCT No.: PCT/FR2020/050216

§ 371 Date: Jul. 27, 2021

(30) Foreign Application Priority Data
Feb. 14, 2019 (FR) 1901518

(51) Int. Cl. B22F 10/28; B33Y 10/00; C22C 14/00; B23K 26/342; B23K 26/06

(52) U.S. Cl. CPC B22F 10/28; B33Y 10/00; C22C 14/00; B23K 2103/14; B23K 26/0626; B22F 2301/205; B23K 26/342

(57) ABSTRACT

A field of additive manufacturing and more particularly to a method of additive manufacturing through the addition of a metallic material, the melting of runs of the metallic material through the application of energy, and solidification of the runs. In this method, the intensity, per unit length of run, of the energy supplied for melting one or more initial runs of the metallic material applied to a first part of a component is appreciably lower than that of the energy supplied for melting one or more subsequent runs of the metallic material added to the initial runs.

### TECHNICAL FIELD

The present invention relates to the field of additive manufacturing and in particular to the field of direct metal deposition (DMD) additive manufacturing.

“Direct metal deposition additive manufacturing process” means an additive manufacturing process in which a metallic material, for example in the form of powder or wire, is brought onto a substrate and melted by an energy beam, for example a laser or electron beam, to form a bead of molten metal on the substrate. After solidifying this bead, other beads can be successively superimposed on it in the same way, to form a three-dimensional metal component.

In patent application publications US 2018/243828 A1, US 2015/306667 A1, and WO 2015/019070 A1 it has also been proposed to modulate the power of the energy beam in direct metal deposition additive manufacturing processes, so as to create partially consolidated zones, which can subsequently be cut or removed.

In the mechanical field, it is sometimes desirable to create frangible zones that can be sacrificed to protect other more critical elements.

### DISCLOSURE OF THE INVENTION

The present disclosure aims to address these drawbacks by providing a process for additive manufacturing of a component that allows a frangible zone to be interposed between a first and a second part of the component to stop the propagation of cracks between said first and second part of the component.

According to a first aspect, this goal can be achieved by the fact that in this process, which comprises the steps of supplying metallic material to a substrate, melting one or more initial beads of the metallic material supplied to the first part of the component, solidifying the initial beads, supplying metallic material to the initial beads, melting of one or more subsequent beads of the metallic material supplied to the initial beads, and solidifying the subsequent beads, the melting of the subsequent beads is carried out by an energy supply of a second intensity per unit length of bead, which is substantially greater than a first intensity per unit length of bead, which is that of the energy supply by which the melting of the initial beads is carried out.

Thanks to these arrangements, the wetting surface of the initial beads on the first part of the component, and thus their adhesion force to this first part, can be less than that between the superimposed beads, thus creating a frangible zone to stop the propagation of cracks between the first part of the component and a second part formed at least partially by the subsequent beads.

According to a second aspect, the metallic material can be supplied in powder form, and in particular be supplied by spraying from a spray nozzle. However, alternatives, such as the supply of a wire of the metallic material, can possibly be envisaged.

According to a third aspect, the initial beads may comprise at least two superimposed beads. Thus, the second, higher intensity of energy supply per unit length of bead may be used only from a third layer of material, thus avoiding that the boundary layer between the substrate and the initial beads may be remelted by the energy supply for melting of the subsequent beads, which could consolidate the substrate to the initial beads.

According to a fourth aspect, the energy supply during the melting steps can be carried out by scanning an energy beam, in particular a laser beam, and more precisely a laser beam emitted in continuous mode. In order to achieve different intensities of energy supply per unit length of the bead, an emission power of the energy beam upon melting of the initial beads may be substantially less than an emission power of the energy beam upon melting of the subsequent beads, and in particular may be between one half and three quarters, and more specifically about two thirds, of the emission power of the energy beam upon melting of the subsequent beads. In this case, a scanning speed and/or laser spot diameter may be substantially equal upon melting of the initial beads and upon melting of the subsequent beads, so as to ensure bead continuity. However, alternative means to the laser beam can be considered to ensure the energy supply during the melting steps, for example an electron beam.

According to a fifth aspect, the material can be a titanium-based alloy, in particular Ti6Al4V. However, nickel-based alloys are also possible.

According to a sixth aspect, the process may comprise a prior step of additive manufacturing of the first part of the component, before the step of supplying metallic material to the first part of the component

### BRIEF DESCRIPTION OF THE DRAWINGS

The invention will be well understood and its advantages will become clearer upon reading the following detailed description of an embodiment shown by way of non-limiting example. The description refers to the appended drawings in which:

FIGS. 1A through 1D schematically illustrate successive steps of an additive manufacturing process according to this embodiment,

FIGS. 2A and 2B illustrate cross-sections of beads of metallic material deposited on a substrate, and melted with different energy supplies per unit length of the bead, and

FIG. 3 illustrates the operation of separating the substrate from a component produced by additive manufacturing according to the process illustrated in FIGS. 1A to 1D

### DESCRIPTION OF THE EMBODIMENTS

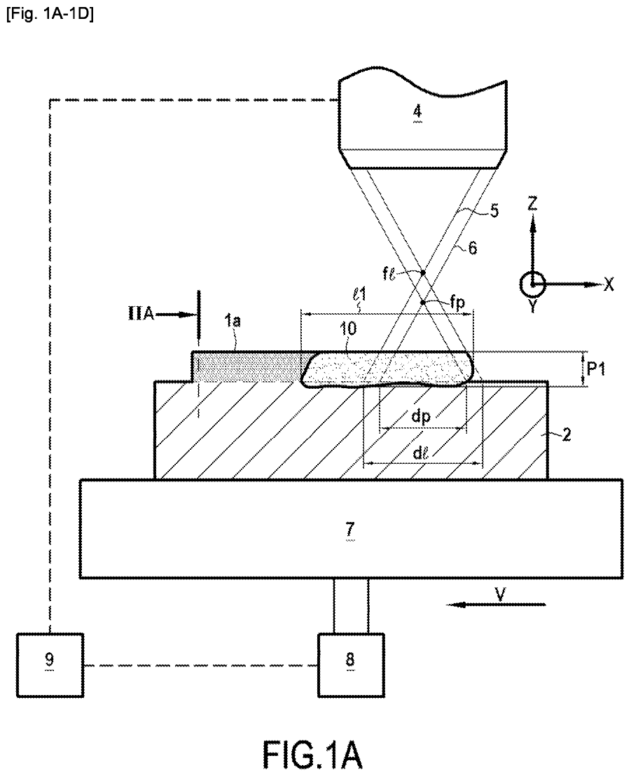

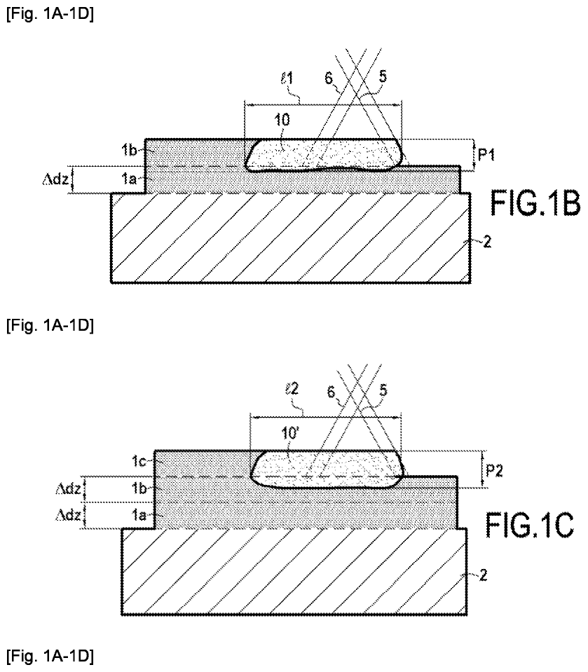

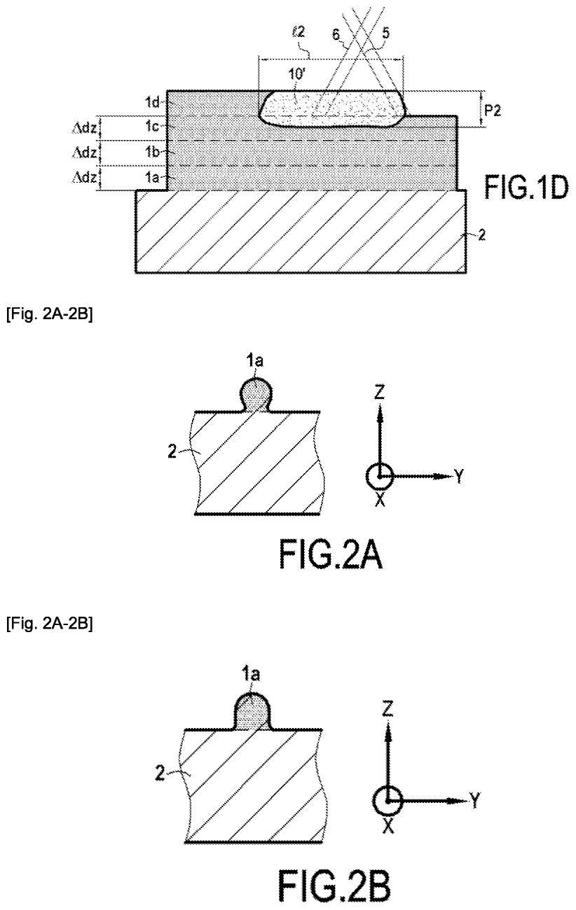

An additive manufacturing process by direct metal deposition, more specifically by laser metal deposition (LMD), is illustrated in FIGS. 1A to 1D. As can be seen in these figures, in this process beads 1a to 1d of metallic material can be successively formed on a substrate, which can be formed by a first part 2 of a three-dimensional component to be manufactured, superposed to create a wall forming a second part 3 of the three-dimensional component. To form each bead 1a to 1d, the metallic material can be sprayed in powder form, comprising particles of diameters for example between 45 and 75 μm, from a spray nozzle 4, and melted by an energy beam 5, while the first part 2, carried for example by a movable table 7 movable in three dimensions XYZ by linear actuators 8 connected to a control unit 9, is moved, relative to the spray nozzle 4, with a scanning speed v of, for example, 200 to 400 mm/min, in a plane XY parallel to the surface of the first part 2. The particles may be impelled by an inert gas such as argon, and form a converging particle beam 6, which may be, as illustrated, coaxial with the energy beam 5, for example using an annular spray nozzle 4. In particular, the metallic material of the particles may be a titanium-based alloy, such as Ti6Al4V, and the particle beam 6 may have a mass flow rate dm/dt of, for example, 2 to 3 g/min.

In order to avoid the rise of impurities, the first part 2 can be made of the same metallic material or of a material with a sufficiently similar composition. The energy beam 5 may be a laser beam, and in particular a continuous laser beam, emitted, for example, by a YAG disc laser or by a fiber laser. The wavelength λ of this laser beam may be, for example, 1030 μm for a disk YAG laser, or 600 μm for a fiber laser. The process can be carried out under an inert atmosphere, in particular under argon.

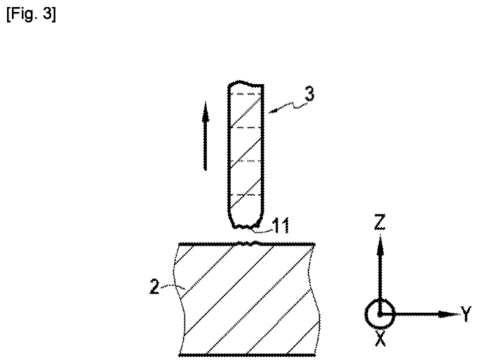

As illustrated in FIG. 1A, a first bead 1a may thus be formed directly on the first part 2. The foci of convergence fₚ and fₗ of the particle beam 6 and the energy beam 5, respectively, may be located above the surface of the first part 2 such that these beams have respective diameters dₚ and dₗ of, for example, 1.5 to 2 mm and 2 to 3 mm, at the surface of the first part 2. Thus, the metallic material is simultaneously deposited on the first part 2 and melted by the energy supply of the energy beam 5, so as to create a liquid bath 10 solidifying downstream with respect to the scanning direction of the particle beams 6 and energy beam 5 on the first part 2, to form this first bead 1a. The energy supply of the energy beam 5 can be regulated so as to minimize the wetting surface of the liquid bath 10 on the first part 2, and therefore the contact surface A_{c} of the bead 1a with the first part 2, as illustrated in FIG. 2A, showing a cross-section of the bead 1A on the first part 2. This regulation can be carried out in particular through the emission power P₁ of the energy beam 5 for this first bead 1a. This first emission power P₁ can thus be, for example, between 350 and 430 W. A liquid bath 10 can thus be obtained with a first depth p₁, which may be, for example, 1.1 mm, and a first length l₁, which may be, for example, 2.6 mm. By way of comparison, if the emission power, and thus the energy supply of the energy beam, were higher, the cross-section of the bead 1a would be as shown in FIG. 2B, with a substantially larger contact area A_{c}, which would increase the cohesion with the first part 2.

In order to create a three-dimensional component, additional beads, subsequently formed analogously to the first bead 1a, may be superimposed, in the Z-axis perpendicular to the surface of the first part 2, on this first bead 1a. To this end, after forming the first bead 1a, the distance in the Z-axis between the first part 2 and the spray nozzle 4 may be increased by an increment Δd_{z}, before beginning to form, on the first bead 1a, a second bead 1b in a similar manner, as illustrated in FIG. 1B. This increment Δd_{z} may be, for example, between 0.7 and 0.9 mm. The various parameters of the particle beams 6 and energy beams 5, such as their convergence angles, mass flow rate dm/dt as well as emission power P₁, used to form the first bead 1a, can be maintained for this second bead 1b, as can the scanning velocity v, so as to maintain substantially the same energy supply per unit length of the bead and thus substantially the same length I₁ and depth p₁ of the liquid bath 10, and to avoid recasting of the first bead 1a at the first part 2.

However, after forming this second bead 1b on the first bead 1a, the energy supply per unit length of bead can be increased substantially to form subsequent beads 1c, 1d superimposed on the first and second beads 1a, 1b, to increase the cohesion between the superimposed beads. Thus, for the subsequent beads, a second emission power P₂ substantially higher than the first emission power P₁ may be used, while maintaining the beam convergence angles 5 and 6, the mass flow rate dm/dt, and the scanning velocity v. In particular, the second emission power P₂ can be one-third to twice the first emission power P₁. Thus, if the first emission power P₁ is between 350 and 430 W, the second emission power P₂ can be about 600 W. In this way, a liquid bath 10′ can be obtained with a second depth p₂ and a second length l₂ substantially greater, respectively, than the first depth p₁ and the first length l₁, which were those of the liquid bath 10 obtained with the first emission power P₁. Thus, for example, the second depth p₂ may increase to 1.7 mm, and the second length l₂ to 3.5 mm.

For each subsequent bead 1c, 1d, the distance in the Z-axis between the first part 2 and the spray nozzle 4 can be further increased by an additional increment Δdₐ, as illustrated in FIGS. 1C and 1D. The superimposed beads 1a to 1d can thus form a second part 3, for example in the form of a wall, with a frangible zone 11 of reduced thickness compared with the second part 3, directly interposed between the first and second parts 2, 3 of the component, thus facilitating their subsequent separation, as illustrated in FIG. 3, in particular to prevent the propagation of cracks between the first and second parts 2, 3 of the component.

Although the present invention has been described with reference to a specific example embodiment, with spraying of the metallic material in powder form and energy supply by laser beam, it is apparent that various modifications and changes can be made to these examples without departing from the general scope of the invention as defined by the claims. For example, the number of initial stacked beads for which the energy supply per unit length of bead is substantially less than that of subsequent beads may be one, rather than two, or more than two. In addition, the energy supply per unit length of bead may be regulated not only through the emission power of the energy beam, but also, alternatively or in addition to this power regulation, through the scanning velocity v and/or the mass flow rate dm/dt of the metallic material supplied. The metallic material can be supplied in the form of wire and/or the energy supply can be carried out by an electron beam. The first part of the component may itself have been manufactured at least partially by additive manufacturing in a step prior to the supply of metallic material to form the frangible zone. Therefore, the description and drawings should be considered in an illustrative rather than restrictive sense.

1. A process for additive manufacturing of a component with a frangible zone interposed between first and second parts of the component to stop the propagation of cracks between said first and second parts of the component, comprising at least the following steps:
supplying metallic material to the first part of the component,
melting one or more initial beads of the metallic material supplied to the first part of the component, by an energy supply of a first intensity per unit length of bead,
solidifying the initial beads,
supplying metallic material to the initial beads,
melting one or more subsequent beads of the metallic material supplied to the initial beads by an energy supply of a second intensity per unit length of bead, which is greater than the first intensity per unit length of bead, and
solidifying the subsequent beads.

2. The additive manufacturing process as claimed in claim 1, wherein the metallic material is supplied in powder form.

3. The additive manufacturing process as claimed in claim 2, wherein the metallic material is supplied by spraying from a spray nozzle.

4. The additive manufacturing process as claimed in claim 1, wherein the initial beads comprise at least two superimposed beads.

5. The additive manufacturing process as claimed in claim 1, wherein the melting of each bead is simultaneous with the supply of corresponding metallic material.

6. The additive manufacturing process as claimed in claim 1, wherein the energy supply during the melting steps is carried out by scanning an energy beam.

7. The additive manufacturing process as claimed in claim 6, wherein the energy beam is a laser beam.

8. The additive manufacturing process as claimed in claim 7, wherein the laser beam is emitted in continuous mode.

9. The additive manufacturing process as claimed in claim 6, wherein an emission power of the energy beam upon melting of the initial beads is less than an emission power of the energy beam upon melting of the subsequent beads.

10. The additive manufacturing process as claimed in claim 9, wherein the emission power of the energy beam upon melting of the initial beads is between one-half and three-quarters of the emission power of the energy beam upon melting of the subsequent beads.

11. The additive manufacturing process as claimed in claim 9, wherein a scanning speed and/or a laser spot diameter are substantially equal upon melting of the initial beads and upon melting of the subsequent beads.

12. The additive manufacturing process as claimed in claim 1, wherein the material is a titanium-based alloy.

13. The additive manufacturing process as claimed in claim 1, comprising a prior step of additive manufacturing of the first part of the component, before the step of supplying metallic material to the first part of the component.
